(19) United States
(12) Patent Application Publication
(10) Pub. No.: US 2014/0093828 A1
(43) Pub. Date: Apr. 3, 2014

(54) ARRANGEMENT AND METHOD OF DRYING FUEL IN A BOILER SYSTEM

(71) Applicants: Pertti Kinnunen, Varkaus (FI); Timo Jäntti, Varkaus (FI); Juha Räsänen, Leppavirta (FI); Juha Palonen, Varkaus (FI)

(72) Inventors: Pertti Kinnunen, Varkaus (FI); Timo Jäntti, Varkaus (FI); Juha Räsänen, Leppavirta (FI); Juha Palonen, Varkaus (FI)

(21) Appl. No.: 14/112,577

(22) PCT Filed: Apr. 18, 2012
(86) PCT No.: PCT/FI2012/050378

§ 371 Date: Dec. 3, 2013

(30) Foreign Application Priority Data
Apr. 20, 2011 (FI) 20115382

(51) Int. Cl. F23K 1/04; F26B 23/00; F23G 5/04

(52) U.S. Cl. CPC F23K 1/04; F23G 5/04; F26B 23/001
USPC 431/11; 110/224; 110/342; 431/215; 34/86

(57) ABSTRACT

A boiler system includes an arrangement for drying fuel material to be combusted in the boiler system. A combustion chamber combusts fuel material, and generates ash and flue gases. An ash removal conduit connected to the combustion chamber leads ash out of the combustion chamber. A flue gas conduit connected to the combustion chamber leads Hue gases out of the combustion chamber. A flue gas heat recovery system, arranged to the flue gas conduit, recovers heat from the flue gases. A fuel dryer, provided with a first heat transfer device, transfers heat into the fuel to be dried. A second heat transfer device is arranged in connection with the flue gas conduit downstream of the flue gas heat recovery system. A third heat transfer device is arranged in connection with the ash removal conduit and a fourth heat transfer device is arranged in heat transfer connection with the fuel dryer.

### CLAIM OF PRIORITY

This application is a U.S. national stage application of PCT International Application No. PCT/FI2012/050378, filed Apr. 18, 2012, published as International Publication No. WO 2012/143609 A1, and which claims priority from Finnish patent-application number 20115382, filed Apr. 20, 2011.

### FIELD OF THE INVENTION

Our invention relates to an arrangement in a boiler system for drying fuel material to be combusted in the boiler system. The arrangement includes a combustion chamber in the boiler system, an ash removal conduit connected to the combustion chamber for leading ash out of the combustion chamber, a flue gas conduit connected to the combustion chamber for leading the Hue gases out of the combustion chamber, a flue gas heat recovery system arranged to the flue gas conduit for recovering hear from the flue gases, a flue dryer provided with a first heat transfer device for transferring heat into the fuel to be dried, a first heat transfer circuit comprising the first heat transfer device, a first circulation conduit, and a second heat transfer device, the second heat transfer device being arranged in connection with the flue gas conduit downstream of the Hue gas heat recovery system.

Our invention also relates to a method of drying fuel material in a boiler system. The method includes the steps of combusting fuel in a combustion chamber of the boiler system, removing ash out of the combustion chamber via an ash removal conduit connected to the combustion chamber, leading hot flue gases out of the combustion chamber via a flue gas conduit connected to the combustion chamber, passing fuel to be combusted into a flue dryer, and drying the fuel by transferring heat to the fuel from a first heat transfer medium flowing in a first heat transfer circuit by means of a first heat transfer device, and transferring heat by means of a second heat transfer device from the flue gases to the first heat transfer medium flowing in the first heat transfer circuit.

### BACKGROUND OF THE INVENTION

Generally speaking, the water content of solid fuel decreases the net heat value in connection with combustion of the solid fuel. Thus, it is advantageous to remove water from the fuel prior to combustion. It is well known to dry the fuel prior to combustion by making use of lower grade heat, i.e., heat at a lower temperature obtained from the combustion, in order to increase plant efficiency.

Drying of the fuel makes use of the heat of the exhaust gas that is transferred to the fuel to be dried by means of the water circuit.

For example, German patent publication DE 38 35 427 shows a steam generator in which a fluidized bed fuel dryer is arranged with an optional closed water circuit to transfer heat from flue gas of the steam generator to a fuel dryer.

International Publication No. WO 90/00219 shows a combined cycle power plant, in which wet fuel is dried in a fuel dryer with a closed water circulation that transfers heat from exhaust gas of a gas turbine to the fuel dryer.

International Publication No. WO 00/73703 shows a combustion apparatus in which wet material to be combusted is dried with superheated steam generated by the flue gases of a combustor.

International Publication No. WO 97/31222 shows a steam generator, in which lignite is dried in a dryer by process steam generated by the exhaust gases of a steam generator.

On the other hand, another source of heat in connection with a combustion process is ash removed from the combustor.

For example, U.S. Pat. No. 4,292,742 shows a method of drying fuel prior to the fuel entering a combustion chamber by heat extracted from hot ashes discharged from the combustion chamber by a closed circulation of gas. Gas is, however, a somewhat poor medium for conveying heat, due to its low specific heat capacity.

U.S. Pat. No. 5,624,469 shows a method of hearing and moistening fuel to be introduced into a combustion chamber by hot water generated by transferring heat from ashes discharged from a combustion chamber.

Even if the methods disclosed in the prior art may be operable, as such, there has emerged a need to further develop the method of drying fuel material in order to increase plant efficiency.

### SUMMARY OF THE INVENTION

An object of the invention is to provide an arrangement and a method in a boiler system for drying fuel material by means of which the plant efficiency may be increased.

Objects of the invention are met by an arrangement in a boiler system for drying fuel material to be combusted in the boiler system. The arrangement comprises a combustion chamber, an ash removal conduit connected to the combustion chamber for leading ash out of the combustion chamber, a flue gas conduit connected to the combustion chamber for leading flue gases out of the combustion chamber, a flue gas heat recovery system arranged to the flue gas conduit for recovering heat from the flue gases, a fuel dryer provided with a first heat transfer device for transferring heat into the fuel to be dried, a first heat transfer circuit comprising the first heat transfer device, a first circulation conduit, and a second heat transfer device, the second heat transfer device being arranged in connection with the flue gas conduit downstream of the flue gas heat recovery system. It is characteristic to the arrangement that the arrangement further comprises a second heat transfer circuit comprising a second circulation conduit, a third heat transfer device and a fourth heat transfer device, and that the third heat transfer device is arranged in connection with the ash removal conduit and the fourth heat transfer device is arranged in heat transfer connection with the fuel dryer for transferring heat utilized in drying of the fuel.

This provides an advantageous effect of utilization of the heat contained both in the flue gases and the hot ash resulting from the combustion in the drying of the fuel material, in a straightforward manner. Thus, by means of the invention, the fuel drying may be accomplished with increased power plant efficiency.

According to an embodiment of the invention, the fourth heat transfer device is arranged in connection with the first heat transfer circuit, via which, the fourth heat transfer device is arranged in heat transfer connection with the fuel dryer.

According to an embodiment of the invention, the flue gas heat recovery system is arranged to operate responsive to the flue gas temperature upstream of the second heat transfer device for maintaining the flue gas temperature at the inlet of the second heat transfer device at a predetermined level.

According to another embodiment of the invention, the second heat transfer device comprises two separate heat exchangers, that is, an upstream heat exchanger and a downstream heat exchanger.

Thus, preferably, the upstream heat exchanger and the downstream heat exchanger are connected to the first heat transfer circuit, in series, so that the heat exchangers operate in counter flow principle with respect to the flue gas flow, and that the first circulation conduit comprises a by-pass conduit.

According to still another embodiment of the invention, the by-pass conduit is provided with a control system for controlling the flow of the first heat transfer medium through the by-pass conduit.

Preferably, the control system comprises a valve unit and a temperature sensor unit arranged to control the portion of the first heat transfer medium by-passing the downstream heat exchanger, responsive to the measured temperature of the flue gas at a location upstream of the downstream heat exchanger.

According to still another embodiment of the invention, the flue gas conduit comprises a by-pass conduit arranged to enable by-passing the second heat transfer device.

According to still another embodiment of the invention, the first heat transfer circuit is provided with an auxiliary heat exchanger to adjust the temperature of the first heat transfer medium.

According to still another embodiment of the invention, the second heat transfer circuit comprises thermo-oil as the heat transfer medium.

Objects of the invention are also met by a method of drying fuel material in a boiler system, comprising the steps of combusting fuel in a combustion chamber of the boiler system, removing ash out of the combustion chamber via an ash removal conduit connected to the combustion chamber, leading hot flue gases out of the combustion chamber via a flue gas conduit connected to the combustion chamber, passing fuel to be combusted in a fuel dryer and drying the fuel by transferring befit to the fuel from a first heat transfer medium flowing in a first heat transfer circuit by means of a first heat transfer device, transferring heat by means of a second heat transfer device from the flue gases lo the first heat transfer medium flowing in the first heat transfer circuit, the method further comprising recovering heat from the ash removed out of the combustion chamber and transferring the heat to the fuel dried in the fuel dryer.

According to one embodiment of the invention, the heat recovered from the ash is transferred to the fuel dryer via the first heat transfer medium flowing in a first heat transfer circuit.

According to another embodiment of the invention, transferring heat by means of a second heat transfer device 28 practiced to cool the flue gas to a temperature of about 110° C. to about 60° C.

According to still another embodiment of the invention, the second heat transfer device is operated so that latent heat of the flue gases also is recovered.

According to another embodiment of the invention, heat is transferred to the second heat transfer device in two stages, by an upstream heat exchanger and a downstream heat exchanger.

According to still another embodiment of the invention, the heat transfer in the upstream heat exchanger is control led to cool the flue gas to a temperature less than or equal to 130° C.

According to still another embodiment of the invention, the heat transfer in the upstream heat exchanger is controlled by arranging a portion of the first heat transfer medium to by-pass the downstream heat exchanger.

### BRIEF DESCRIPTION OF THE DRAWINGS

In the following, the invention will be described with reference to the accompanying schematic drawings, in which

FIG. 1 illustrates a boiler system according to an embodiment of the invention;

FIG. 2 illustrates a boiler system according to another embodiment of the invention;

FIG. 3 illustrates a boiler system according to still another embodiment of file invention; and

FIG. 4 illustrates a boiler system according to yet another embodiment of the invention.

### DETAILED DESCRIPTION OF THE PREFERRED EMBODIMENTS

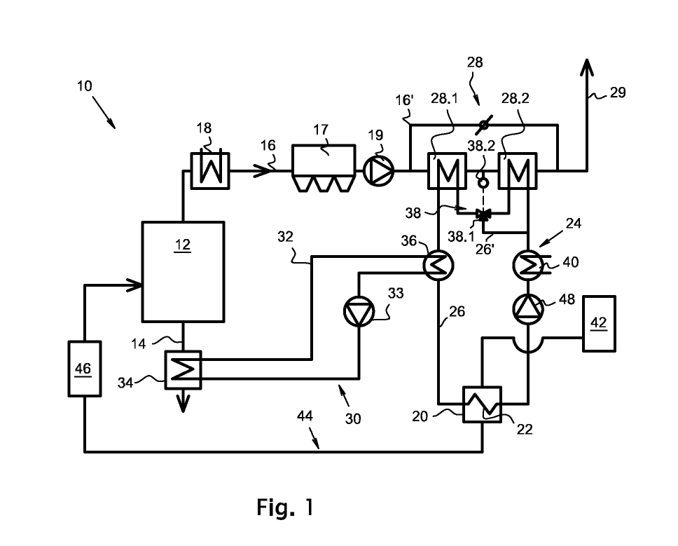

FIG. 1 schematically shows a boiler system 10, in which solid fuel is combusted for producing heat and/or electrical power. The boiler system 10 comprises a combustion chamber 12, including a boiler, in which fuel material is combusted in a manner knows as such. Heat released in the combustion is recovered, e.g., as steam or superheated steam and/or heated water in a heat recovery system 18 of the boiler system 10, which heat recovery system 18 is arranged in the flow path of the flue gases in a flue gas conduit 16. The flue gas conduit 16 is arranged in connection with the combustion chamber 12 and leads to a stack 29 of the boiler system 10. The heat recovery system 18 preferably comprises evaporation and/or steam superheating devices, as well as combustion gas and feed water pre-heaters. After the recovery system 18, there is a flue gas cleaning system 17, such as an electrostatic precipitator (ESP), arranged in the flue gas conduit 16. The flue gas conduit 16 also comprises a flue gas fan 19 to facilitate the flow of flue gases through, the boiler system 10.

Fuel material to be combusted is stored in fuel storage 42, from which it is conveyed to the combustion chamber 12 by means of a fuel transportation and handling line 44. The fuel feeding line 44 comprises at least a fuel dryer 20 and a day storage 46, from which the dried fuel is fed to the combustion chamber 12. The fuel dryer 20 is arranged upstream of the day storage 46, so that the fuel in the day storage 46 is already dried fuel. The fuel dryer 20 comprises a first heat transfer device 22, which is arranged to transfer heat to the fuel needed for a drying process in the fuel dryer 20. The actual construction and drying principle of the fuel dryer 20 may be selected according to a specific case. It may be, for example, a belt, a disc, or a fluidized bed dryer, known as such.

At a location of the flue gas conduit 16, where the flue gases have already been cooled down to about 130° C. to about 160° C., a second heat transfer device 28 is arranged. Typically, this location is just prior to the stack 29 of the boiler system 10. The first heat transfer device 22 and the second heat transfer device 28 are connected to a first heat transfer circuit 24, in which a first circulation conduit 26 is arranged to circulate a first heat transfer fluid, in order to transfer heat from the second heat transfer device 28 to the first heat transfer device 22. The circuit 24 comprises a circulation pump 48 to provide the circulation. This way, the heat transferred from the flue gases is conveyed to the fuel dryer 20. There is also an auxiliary heat exchanger 40 in the circuit 24, providing additional cooling or heating of the first heat exchanger fluid in special occasions, in order to adjust the temperature of the first heat transfer medium.

Combusting of solid fuel in the combustion chamber 12 results in the formation of ash, particularly, so-called bottom ash, which must be removed from the combustion chamber 12, specifically, from the bottom part thereof. The boiler system 10 comprises an ash removal conduit 14 connected to the bottom part of the combustion chamber 12. The ash removal conduit 14 is provided with a third heat transfer device 34 arranged to cool the removed ash and to heat the heat transfer medium in a second heat transfer circuit 30. The second heat transfer circuit 30 comprises a second circulation conduit 32 having at least a pump 33, the third heat transfer device 34, and a fourth heat transfer device 36. Now, the fourth heat transfer device 36 is arranged in connection with the first heat transfer circuit 24, so that the heat obtained from the hot ash removed from the combustion chamber 12 is utilized to increase the temperature of the first heat transfer medium in the first heat transfer circuit 24 prior to its entry into the fuel dryer 20. Thus, advantageously, the fourth heat transfer device 36 is arranged in the first circuit 24 downstream of the second hear transfer device 28 with respect to the flow direction of the first heat transfer medium. This way, the first heat transfer medium is at its highest temperature when entering the fuel dryer 20. The hear transfer medium in the second heat transfer circuit 30 is preferably thermo-oil. This way, the second heat transfer circuit 30, even if it operates at high temperatures, remains simple due to low pressure requirements.

The fuel drying concept according to the invention is, due to its high efficiency, specifically suitable for drying fuels of a high moisture content, such as coal, lignite, and biofuel, thus, increasing the total efficiency of the power plant. Fuel drying is accomplished by utilizing heat recovered from the flue gases and bottom ash of the boiler system 10. Heat from the flue gases and the bottom ash is transferred to the fuel dryer 20 indirectly with a closed heat transfer medium circulation.

According to an advantageous embodiment of the invention, the second heat transfer device 28 comprises two separate heat exchangers, an upstream heat exchanger 28.1 and a downstream heat exchanger 28.2. This has tut advantageous effect with respect to the operation due to the fact that the heat transfer may be distinctly divided into dry (non-condensing) and wet (condensing) heat transfer. Thus, the flue gas energy is recovered in two stages.

The upstream heat exchanger 28.1 is preferably an austenitic or similar corrosion resistant tubular type flue gas heat exchanger and the downstream heat exchanger 28.2 is preferably a plastic tubular type flue gas heat exchanger.

The upstream heat exchanger 28.1 and the downstream heat exchanger 28.2 are connected to the first heat transfer circuit 24 in series so that the heat exchangers operate in counter flow principle with respect to the flue gas flow in the flue gas conduit 16. The first circulation conduit 26 also comprises a by-pass conduit 26′ leading from an inlet side of the downstream heat exchanger 28.2 to its outlet side and to the inlet side of the upstream heat exchanger 28.1. The by-pass conduit 26′ is provided with a control system 38 comprising valve 38.1 for controlling the flow of the first heat transfer medium through the downstream heat exchanger 28.2.

The control system 38 further comprises a temperature sensor unit 38.2 arranged in the flue gas conduit 16 at a location upstream of the downstream heat exchanger 28.2. This way, the portion of the first heat transfer medium by-passing the downstream heat exchanger 28.2 is controlled to be responsive to the measured temperature of the flue gas. The temperature of the flue gases entering the downstream heat exchanger 28.2 is maintained at a predetermined level by controlling the heat transferred from the flue gases in the upstream heat exchanger 28.1. The greater the portion of the first heat transfer medium by-passing the second heat, exchanger 28.2 is, the cooler the first heat transfer medium entering the first heat exchanger 28.1 is, and the more effective the heat transfer in the first heat exchanger is.

The predetermined temperature maintained by controlling the heat transferred from the flue gases in the upstream heat exchanger 28.1 is less than or equal to 130° C., i.e., the heat transfer in the upstream heat exchanger 28.1 is controlled to cool the flue gas to a temperature of less than or equal to 130° C.

The flue gas conduit 16 is provided with a controllable by-pass conduit 16′, by means of which, the second heat transfer device may be fully by-passed in a case when fuel drying is not operated.

When the boiler system 10 is in operation, fuel is combusted in the combustion chamber 12 of the boiler system 10, which generates heat. Hot flue gases are led out of the combustion chamber 12 via the flue gas conduit 16, which is connected to the combustion chamber 12. The ash resulting from the combustion of the fuel is removed from the combustion chamber 12 via the ash removal conduit 14 connected to the bottom section of the combustion chamber 12. The fuel to be combusted is passed into the fuel dryer 20 and it is dried by transferring heat from the first heat transfer medium flowing in the first heat transfer circuit 24 by means of the first heat transfer device 22 arranged in the fuel dryer 20. Heat from the flue gases is transferred by means of the second heat transfer device 28 from the flue gases to the first heat transfer medium flowing in the first heat transfer circuit 24, which heat is utilized in the fuel dryer 20.

Additional heat is recovered from the ash that is removed from the combustion chamber 12. The heat thus obtained from the hot ash is transferred to the first heat transfer medium flowing in the first heat transfer circuit 24.

Advantageously, the heat from the flue gases transferred by means of the second heat transfer device 28 is practiced so that the latent heat of the flue gases is also recovered. Thus, heat is transferred by means of the second heat transfer device 28 to cool the flue gas to the temperature of about 110° C. to about 60° C.

The first heat transfer medium is heated to a temperature of about 70° C. to about 110° C. in the upstream heat exchanger 28.1 and the downstream heat exchanger 28.2 connected to the first heat transfer circuit 24 in series. In the fourth heat transfer device 36 of the second heat transfer circuit 30, the first heat transfer medium is further heated to a temperature of about 120° C. to about 130° C. prior to being fed into the fuel dryer 20. The heat transfer medium in the second heat transfer circuit 30, i.e., the thermo-oil, is preferably heated to a temperature of about 200° C. in the third heat transfer device 34.

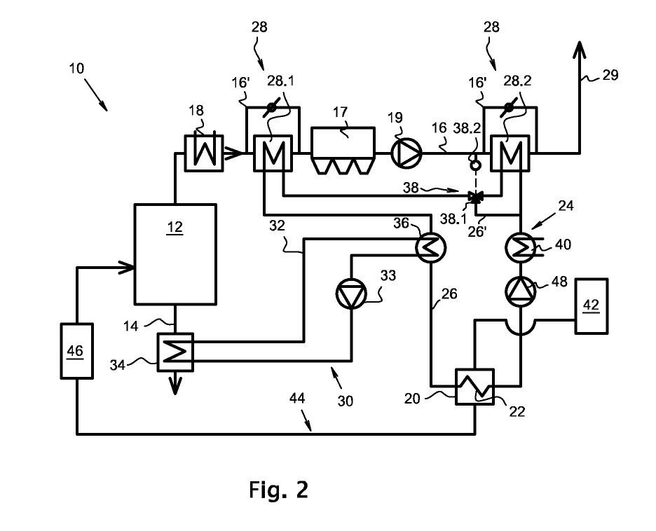

FIG. 2 shows another embodiment of the invention, in which the basic components and the operation corresponds to those shown in FIG. 1. Thus, corresponding reference numbering is also used. The major difference is in the layout. In FIG. 2, the upstream heat exchanger 28.1 is positioned upstream of the flue gas cleaning system 17 (ESP) and the flue gas fan 19. Also, in this embodiment, the flue gas conduit 16 is provided with a controllable by-pass 16′. Thus, in this case, there is a separate by-pass conduit for each heat exchanger, by means of which, both of the separate heat exchangers of the second heat transfer device may be bypassed in a case in which fuel drying is not conducted. The operations of the boiler system and the fuel dryer shown in FIG. 2 corresponds to those shown in the embodiment of FIG. 1.

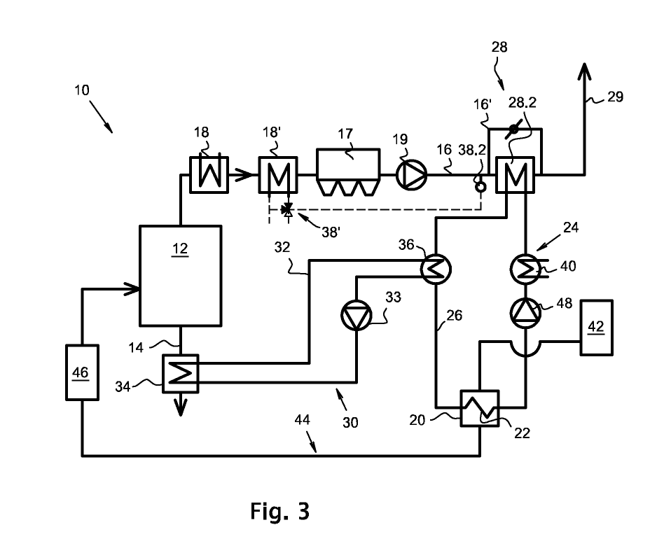

FIG. 3 shows still another embodiment of the invention. In FIG. 3, corresponding reference numbering to those in FIG. 1 is used. In the embodiment of FIG. 3, the second heat transfer device 28 comprises only one heat exchanger, which corresponds to the downstream heat exchanger 28.2, although being dimensioned somewhat more effectively. In this embodiment, the heat recovery system 18 of the boiler system comprises a section 18′, by means of which temperature of the flue gases entering the heat exchanger 28.2 is maintained at a predetermined level by controlling 38′ the heat transferred from the flue gases in the heat recovery section 18′.

In this embodiment, the heat exchanger 28.2 is preferably a plastic tabular type flue gas heat exchanger.

Thus, the heat recovery system 18 and/or the section of the heat recovery system 18 is arranged to operate responsively to the flue gas temperature upstream of the heat exchanger device 28. This way, a predetermined temperature, that is, less than or equal to 130° C., is maintained by controlling the heat transferred from the flue gases in the heat recovery section 18′, i.e., the heat transfer is controlled to cool the flue gas to a temperature of less than or equal to 130° C.

The section 18′ of heat recovery system 18 may be an integral part of the heat recovery system 18, or it may be a separate section. According to an embodiment of the invention, a combustion air pre-heater is used as the section 18′ of heat recovery system 18, the operation of which is controlled to maintain the predetermined temperature at a desired level.

Also, in this embodiment, the flue gas conduit 16 is provided with a controllable by-pass 16′, by means of which the second heat transfer device may be bypassed, in a case in which fuel drying is not performed. The operation of the boiler system 10 and the fuel dryer 20 in the embodiment shown in FIG. 3 corresponds to that of the embodiment shown in FIG. 1.

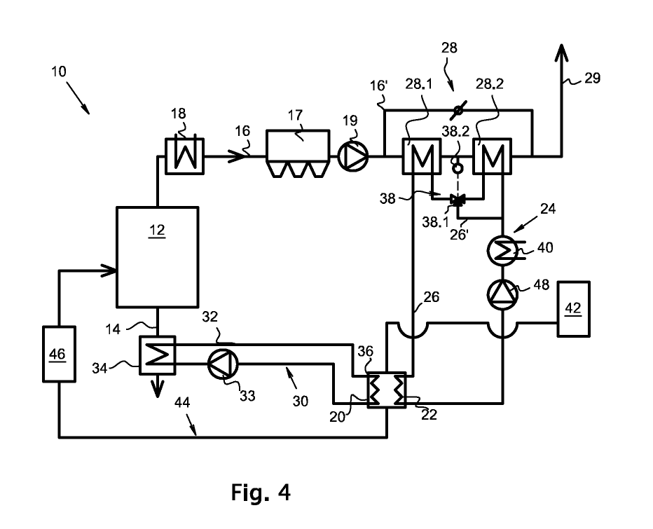

FIG. 4 shows still another embodiment of the invention. Also, in FIG. 4. reference numbers corresponding to those in FIG. 1 are used as applicable. In the embodiment of FIG. 4, the fuel dryer 20 is provided with separate heat transfer devices for the first heat transfer circuit 24 and tor the second heat transfer circuit 30. This may be realized in practice, for example, so that the heating of air used in the drying process is first practiced with the first heat transfer device 24 and, secondly, with the fourth heat transfer device 36.

The operation of the boiler system 10 and the fuel dryer 20 in the embodiment shown in FIG. 4 corresponds to that shown in FIG. 1 in other respects.

It is to be noted that only a few most advantageous embodiments of the invention have been described above. Thus, it is clear that the invention is not limited to the above-described embodiments, but may be applied in many ways within the scope of the appended claims. The features disclosed in connection with the various embodiments can also be used in connection with other embodiments, within the inventive scope, and/or different assemblies can be combined from the disclosed features, should it be desired and should it be technically feasible.

1-17. (canceled)

18. An arrangement in a boiler system for drying fuel material to be combusted in the boiler system, the arrangement comprising:
a combustion chamber for combusting fuel material therein, and generating ash and due gases from the combustion;
an ash removal conduit connected 10 the combustion chamber for leading ash from the combustion out of the combustion chamber;
a flue gas conduit connected to the combustion chamber for leading flue gases out of the combustion chamber;
a flue gas heat recovery system arranged to the flue gas conduit for recovering heat from the flue gases;
a fuel dryer provided with a first heat transfer device for transferring heat into the fuel to be dried;
a first heat transfer circuit comprising the first heat transfer device, a first circulation conduit, and a second heat transfer device, the second heat transfer device being arranged in connection with the flue gas conduit downstream of the flue gas heat recovery system; and
a second heat transfer circuit comprising a second circulation conduit, a third heat transfer device and a fourth heat transfer device, the third heat transfer device being arranged in connection with the ash removal conduit and the fourth heat transfer device being arranged in heat transfer connection with the fuel dryer.

19. An arrangement in a boiler system for drying fuel material according to claim 18, wherein the fourth heat transfer device is arranged in heat transfer connection with the fuel dryer via the first heat transfer circuit.

20. An arrangement in a boiler system for drying fuel material according to claim 18, wherein the second heat transfer device comprises two separate heat exchangers, an upstream heat exchanger and a downstream heat exchanger.

21. An arrangement in a boiler system for drying fuel material according to claim 20, wherein the upstream heat exchanger and the downstream heat exchanger are connected to the first heat transfer circuit in series, so that the heat exchangers operate in counter flow principle with respect to the flue gas flow, and that the first circulation conduit comprises a by-pass conduit to bypass the downstream heat exchanger.

22. An arrangement in a boiler system for drying feel material according to claim 21, wherein the first circulation conduit comprises a by-pass conduit to bypass the downstream heat exchanger.

23. An arrangement in a boiler system for drying fuel material according to claim 22, wherein the by-pass conduit is provided with a control system for controlling the flow of the first heat transfer medium through the by-pass conduit.

24. An arrangement in a boiler system for drying fuel material according to claim 23, wherein the control system comprises a valve unit and a temperature sensor unit arranged to control the portion of the first heat transfer medium by-passing the downstream heat exchanger, responsive to the measured temperature of the flue gas at a location upstream of the downstream heat exchanger.

25. An arrangement in a boiler system for drying fuel material according to claim 18, wherein the first heat transfer circuit is provided with an auxiliary heat exchanger to adjust the temperature of the first heat transfer medium.

26. An arrangement in a boiler system for drying fuel material according to claim 18, wherein the second heat transfer circuit comprises thermo-oil as a heat transfer medium.

27. An arrangement in a boiler system for drying fuel material according to claim 18, wherein the flue gas heat recovery system is arranged to operate responsive to the flue gas temperature upstream of the second heat transfer device.

28. A method of drying fuel material in a boiler system, the method comprising the steps of:
combusting fuel in a combustion chamber of the boiler system and generating ash and flue gases from the combustion;
removing ash out of the combustion chamber via an ash removal conduit connected to the combustion chamber;
leading hot flue gases from the combustion chamber via a flue gas conduit connected to the combustion chamber;
passing fuel to be combusted into a fuel dryer and drying the fuel by transferring heat to the fuel from a first heat transfer medium flowing in a first heat transfer circuit by means of a first heat transfer device;
transferring heat by means of a second heat transfer device from the flue gases to the first heat transfer medium flowing in the first heat transfer circuit; and
recovering heat from the ash removed out of the combustion chamber and transferring the heat to the fuel being dried in the fuel dryer.

29. A method of drying fuel material in a boiler system according to claim 28, further comprising transferring the heat recovered from the ash to the fuel drier via the first heat transfer medium flowing in the first heat transfer circuit.

30. A method of drying fuel material in a boiler system according to claim 28, further comprising transferring heat by the second heat transfer device to cool the flue gas to a temperature of about 60° C. to about 110° C.

31. A method of drying fuel material in a boiler system, according to claim 28, further comprising operating the second heat transfer device so mat latent heat of flue gases is also recovered.

32. A method of drying fuel material in a boiler system according to claim 28, further comprising transferring heat to the second heat transfer device in two stages, by an upstream heat exchanger and a downstream heat exchanger.

33. A method of drying fuel material in a boiler system according to claim 32, further comprising controlling the heat transfer in the upstream heat exchanger to cool the flue gas to a temperature of less than or equal to 130° C.

34. A method of drying fuel material in a boiler system according to claim 32. further comprising controlling the heat transfer in the upstream heat exchanger by causing a portion of the first heat transfer medium to by-pass the downstream heat exchanger.

35. A method of drying fuel material in a boiler system according to claim 34, further comprising controlling the portion by-passing the downstream heat exchanger to be responsive to the inlet flue gas temperature of the downstream heat exchanger.
